(19) United States
(12) Patent Application Publication
(10) Pub. No.: US 2025/0387975 A1
(43) Pub. Date: Dec. 25, 2025

(54) THREE DIMENSIONAL SHAPING DEVICE AND MANUFACTURING METHOD FOR THREE DIMENSIONAL SHAPED OBJECT

(71) Applicant: SEIKO EPSON CORPORATION, Tokyo (JP)

(72) Inventor: Atsushi MAJIMA, ASAHI-MURA (JP)

(21) Appl. No.: 19/247,050

(22) Filed: Jun. 24, 2025

(30) Foreign Application Priority Data
Jun. 24, 2024 (JP) 2024-101244

(51) Int. Cl. B29C 64/393; B33Y 10/00; B33Y 30/00; B33Y 50/02

(52) U.S. Cl. CPC B29C 64/393; B33Y 10/00; B33Y 30/00; B33Y 50/02

(57) ABSTRACT

A three dimensional shaping device includes a plasticizing section that plasticizes a material to generate a shaping material; a nozzle that communicates with the plasticizing section and that includes an ejection port for ejecting the shaping material toward a stage; a movement mechanism that changes a relative position between the nozzle and the stage; a shaping data holding section that holds shaping data for shaping a three dimensional shaped object; and a control section that controls ejection of the shaping material from the nozzle and the movement mechanism in accordance with the shaping data read from the shaping data holding section to shape the three dimensional shaped object, wherein the control section loads new shaping data into the shaping data holding section during a shaping period in which the three dimensional shaped object is shaped.

The present application is based on, and claims priority from JP Application Serial Number 2024-101244, filed Jun. 24, 2024, the disclosure of which is hereby incorporated by reference herein in its entirety.

### BACKGROUND

### 1. Technical Field

The present disclosure relates to a three dimensional shaping device and a manufacturing method for a three dimensional shaped object.

### 2. Related Art

In general, a three dimensional shaping device shapes a three dimensional shaped object in accordance with shaping data in which information such as a movement path of a nozzle is recorded (refer to, for example, JP-A-2020-82558).

When the size of a file in which shaping data is stored is large, it may take a long time to load data into a memory of the three dimensional shaping device, and it may take a long time before shaping of the three dimensional shaped object can begin.

### SUMMARY

According to a first aspect of the present disclosure, a three dimensional shaping device is provided.

The three dimensional shaping device includes a plasticizing section that plasticizes a material to generate a shaping material; a nozzle that communicates with the plasticizing section and that includes an ejection port for ejecting the shaping material toward a stage; a movement mechanism that changes a relative position between the nozzle and the stage; a shaping data holding section that holds shaping data for shaping a three dimensional shaped object; and a control section that controls ejection of the shaping material from the nozzle and the movement mechanism in accordance with the shaping data read from the shaping data holding section to shape the three dimensional shaped object, wherein the control section loads new shaping data into the shaping data holding section during a shaping period in which the three dimensional shaped object is shaped.

According to a second aspect of the present disclosure, a manufacturing method for a three dimensional shaped object is provided.

The manufacturing method includes a step of plasticizing a material by a plasticizing section to generate a shaping material; a step of a control section causing ejection of the shaping material from a nozzle toward a stage while changing a relative position between the nozzle and a stage in accordance with shaping data read from a shaping data holding section that holds the shaping data for shaping a three dimensional shaped object; and a step of loading new shaping data into the shaping data holding section by the control section, wherein during a shaping period in which the three dimensional shaped object is shaped, the new shaping data is loaded into the shaping data holding section.

### BRIEF DESCRIPTION OF THE DRAWINGS

FIG. 1 is an explanatory diagram showing a schematic configuration of a three dimensional shaping device.

FIG. 2 is a perspective view of a flat screw.

FIG. 3 is a schematic plan view of a barrel.

FIG. 4 is an explanatory diagram schematically showing a basic operation of the three dimensional shaping device.

FIG. 5 is an explanatory diagram showing a program structure of a motion control program.

FIG. 6 is a flowchart of a shaping data loading process.

FIG. 7 is a flowchart of a shaping data loading process according to a second embodiment.

FIG. 8 is a diagram schematically showing a part of a three dimensional shaped object.

### DESCRIPTION OF EMBODIMENTS

### a. First Embodiment

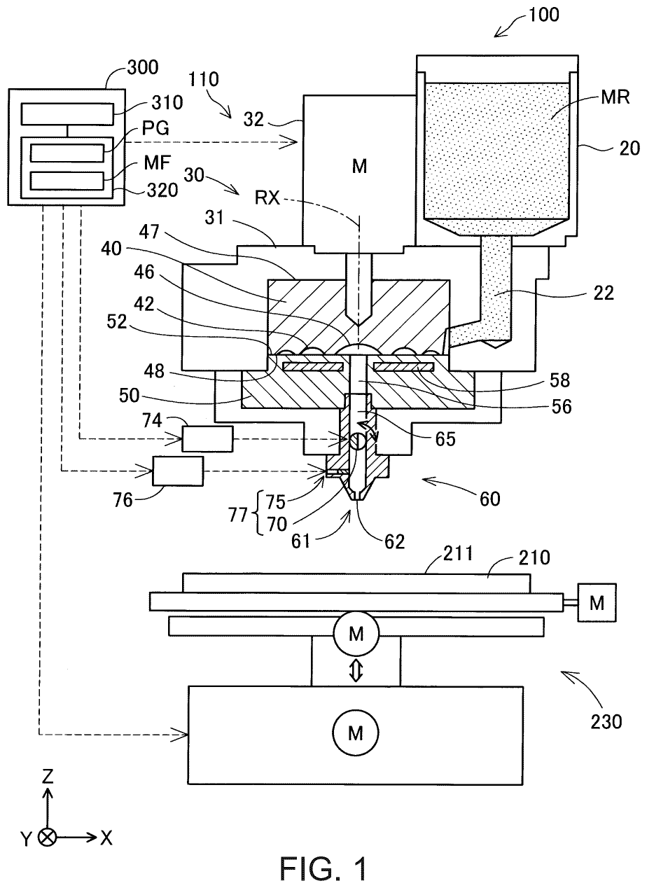

FIG. 1 is an explanatory diagram showing a schematic configuration of a three dimensional shaping device 100 in a first embodiment. In FIG. 1, arrows indicating X, Y, and Z directions orthogonal to each other are shown. The X direction and the Y direction are directions parallel to a horizontal plane, and the Z direction is a direction along a vertically upward direction. The arrows indicating the X, Y, and Z directions are appropriately shown in other drawings so that the shown directions correspond to those in FIG. 1. In the following description, when a direction is specified, a direction indicated by an arrow in each drawing is referred to as “+” and an opposite direction is referred to as “−”, and positive and negative signs are used in combination for direction notation. Hereinafter, the +Z direction is also referred to as “upper”, and the −Z direction is also referred to as “lower”.

The three dimensional shaping device 100 of the present embodiment is a device that shapes a three dimensional shaped object by a material extrusion method. The three dimensional shaping device 100 includes a shaping section 110 that generates and ejects a shaping material, a shaping stage 210 serving as a base for a three dimensional shaped object, a movement mechanism 230 that controls an ejection position of the shaping material, and a control section 300 that controls each section of the three dimensional shaping device 100.

The shaping section 110 ejects a shaping material, which is plasticized from a solid state material, onto the stage 210 under the control of the control section 300. The shaping section 110 includes a material supply section 20, which is a supply source of a raw material MR before being converted into a shaping material, a plasticizing section 30 that converts the raw material MR into a shaping material, and an ejection section 60 that ejects the shaping material.

The material supply section 20 supplies the raw material MR to the plasticizing section 30. The material supply section 20 is constituted by, for example, a hopper that accommodates the raw material MR. The material supply section 20 is connected to the plasticizing section 30 via a communication path 22. The raw material MR is supplied to the material supply section 20 in the form of pellets, powder, or the like. As the raw material MR, for example, a resin material such as acrylonitrile butadiene styrene (ABS), polyether ether ketone (PEEK), or polypropylene (PP) is used. The raw material MR may contain an inorganic material such as a metal or a ceramic.

The plasticizing section 30 plasticizes the raw material MR, which is supplied from the material supply section 20, to generate a paste-like shaping material, which has fluidity, and leads the paste-like shaping material to the ejection section 60. In the present embodiment, “plasticization” means a concept including melting, and means a change from a solid state to a fluid state. Specifically, in a case of a material in which glass transition occurs, plasticization means that the temperature of a material is set to be equal to or higher than the glass transition point. For a material in which glass transition does not occur, plasticization means that the temperature of a material is set to be equal to or higher the melting point.

The plasticizing section 30 includes a screw case 31, a drive motor 32, a flat screw 40, and a barrel 50. The flat screw 40 is also referred to as a rotor or scroll. The barrel 50 is also referred to as a screw facing section.

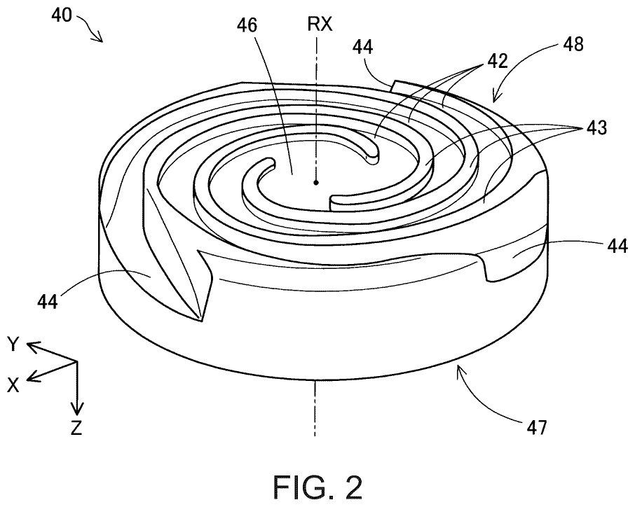

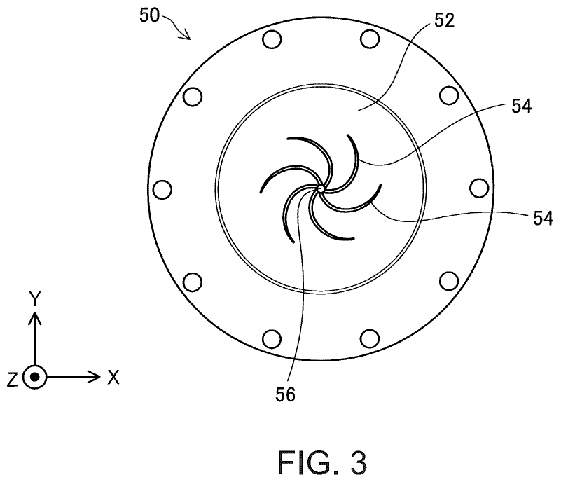

FIG. 2 is a perspective view showing a schematic configuration of a lower surface 48 side of the flat screw 40. The flat screw 40 shown in FIG. 2 is shown with a positional relationship between an upper surface 47 and the lower surface 48 shown in FIG. 2 reversed in the vertical direction for facilitating understanding of the technology. FIG. 3 is a schematic plan view showing an upper surface 52 side of the barrel 50. The flat screw 40 has a substantially cylindrical shape whose length in an axial direction, which is a direction along its central axis, is smaller than a length in a direction perpendicular to the axial direction. The flat screw 40 is arranged so that a rotation axis RX, which serves as a rotation center of the flat screw 40, is parallel to the Z direction.

As shown in FIG. 1, the flat screw 40 is housed in a screw case 31. The upper surface 47 of the flat screw 40 is connected to the drive motor 32, and the flat screw 40 rotates in the screw case 31 by a rotational driving force generated by the drive motor 32. The drive motor 32 is driven under the control of the control section 300. The flat screw 40 may be driven by the drive motor 32 via a decelerator.

As shown in FIG. 2, a spiral groove section 42 is formed on the lower surface 48 of the flat screw 40, which is a surface intersecting the rotation axis RX. The communication path 22 of the material supply section 20 described above communicates with the groove section 42 from a side surface of the flat screw 40. In the present embodiment, three groove sections 42, which are spaced apart, are formed by ridge sections 43. Note that the number of groove sections 42 is not limited to three, and may be one or two or more. The groove section 42 is not limited to a spiral shape, it may be a spiral or involute curve shape, or it may be a shape extending so as to draw an arc from a central section 46 to the outer periphery.

The lower surface 48 of the flat screw 40 faces the upper surface 52 of the barrel 50, and a space is formed between the groove sections 42 of the lower surface 48 of the flat screw 40 and the upper surface 52 of the barrel 50. The raw material MR is supplied into this space between the flat screw 40 and the barrel 50 from the material supply section 20 through material inflow ports 44 shown in FIG. 2.

As shown in FIG. 1, a barrel heater 58 for heating the raw material MR supplied into the groove sections 42 of the rotating flat screw 40 is embedded in the barrel 50. A communication hole 56 is provided at the center of the barrel 50. As shown in FIG. 3, the upper surface 52 of the barrel 50 is formed with a plurality of guide grooves 54 which are connected to the communication hole 56 and extend in a spiral pattern from the communication hole 56 toward the outer periphery. Note that one end of the guide grooves 54 may not be connected to the communication hole 56. It is also possible to omit the guide grooves 54.

The raw material MR supplied into the groove sections 42 of the flat screw 40 flows along the groove sections 42 by the rotation of the flat screw 40 while being plasticized in the groove sections 42, and is guided to the central section 46 of the flat screw 40 as a shaping material. A paste-like shaping material, which has fluidity and flowed into the central section 46, is supplied to the ejection section 60 through the communication hole 56 provided in the center of the barrel 50. Note that in a shaping material, not all types of substances that constitute the shaping material need to be plasticized. The shaping material may be converted into a state having fluidity as a whole by plasticizing at least some kinds of substances that constitute the shaping material.

The ejection section 60 of FIG. 1 includes a nozzle 61 that ejects a shaping material, a flow path 65 of the shaping material provided between the flat screw 40 and an ejection port 62, and an ejection control section 77 that controls the ejection of the shaping material.

The nozzle 61 is connected to the communication hole 56 of the barrel 50 through the flow path 65. The nozzle 61 ejects a shaping material generated in the plasticizing section 30 from the ejection port 62 at a tip end toward the stage 210.

The ejection control section 77 includes an ejection adjustment section 70 that opens and closes the flow path 65, and a suction section 75 that sucks and temporarily stores a shaping material.

The ejection adjustment section 70 is provided in the flow path 65, and changes the opening degree of the flow path 65 by rotating in the flow path 65. In the present embodiment, the ejection adjustment section 70 is constituted by a valve. The ejection adjustment section 70 is driven by a first drive section 74 under the control of the control section 300. The first drive section 74 is formed of, for example, a servo motor. The control section 300 can adjust the flow amount of a shaping material flowing from the plasticizing section 30 to the nozzle 61, that is, the ejection amount of the shaping material ejected from the nozzle 61 by controlling the rotation angle of the valve using the first drive section 74. The ejection adjustment section 70 can adjust the ejection amount of the shaping material and can control ON and OFF of outflow of shaping material.

The suction section 75 is connected between the ejection adjustment section 70 and the ejection port 62 in the flow path 65. The suction section 75 temporarily sucks a shaping material in the flow path 65 when ejection of the shaping material from the nozzle 61 is stopped, thereby suppressing the tailing phenomenon in which the shaping material drips from the ejection port 62 in a string-like manner. In the present embodiment, the suction section 75 is composed of a plunger. The suction section 75 is driven by a second drive section 76 under the control of the control section 300. The second drive section 76 is constituted by, for example, a servo motor, a rack and pinion mechanism for converting the rotational force of the servo motor into a translational motion of the plunger, or the like.

The stage 210 is arranged at a position facing the ejection port 62 of the nozzle 61. A shaping surface 211 of the stage 210 facing the ejection port 62 of the nozzle 61 is arranged to be parallel to the X and Y directions, that is, the horizontal direction. The stage 210 may be provided with a stage heater to prevent rapid cooling of a shaping material ejected onto the stage 210.

The movement mechanism 230 changes a relative position between the stage 210 and the nozzle 61 under the control of the control section 300. In the present embodiment, a position of the nozzle 61 is fixed, and the movement mechanism 230 moves the stage 210. The movement mechanism 230 is constituted by a three-axis positioner that moves the stage 210 in the three axial directions of X, Y, and Z by the drive forces of three servo motors. In the present specification, unless otherwise specified, movement of the nozzle 61 means that the nozzle 61 or the ejection section 60 is relatively moved with respect to the stage 210.

Note that in an other embodiment, instead of a configuration in which the stage 210 is moved by the movement mechanism 230, a configuration may be employed in which a position of the stage 210 is fixed and the movement mechanism 230 moves the nozzle 61 with respect to the stage 210. A configuration in which the movement mechanism 230 moves the stage 210 in the Z direction and the nozzle 61 in the X and Y directions, or a configuration in which the movement mechanism 230 moves the stage 210 in the X and Y directions and the nozzle 61 in the Z direction, may be adopted. Even in these configurations, the relative positional relationship between the nozzle 61 and the stage 210 can be changed.

The control section 300 is configured by a computer including one or a plurality of processors 310, a storage section 320 consisting of a main storage device and an auxiliary storage device, and an input/output interface that inputs and outputs signals to and from the outside. The processor 310 executes a motion control program PG stored in the storage section 320 to control the shaping section 110 and the movement mechanism 230 in accordance with shaping data recorded in a shaping file MF stored in the storage section 320, thereby forming a three dimensional shaped object on the stage 210. The shaping file MF is acquired, for example, from an other computer connected to the control section 300 via a communication line, or from a recording medium, and is stored in the storage section 320. Note that the control section 300 may be realized by a configuration of a combination of circuits, instead of being configured by a computer. That is, functions realized by the program in the present embodiment may be realized by a circuit.

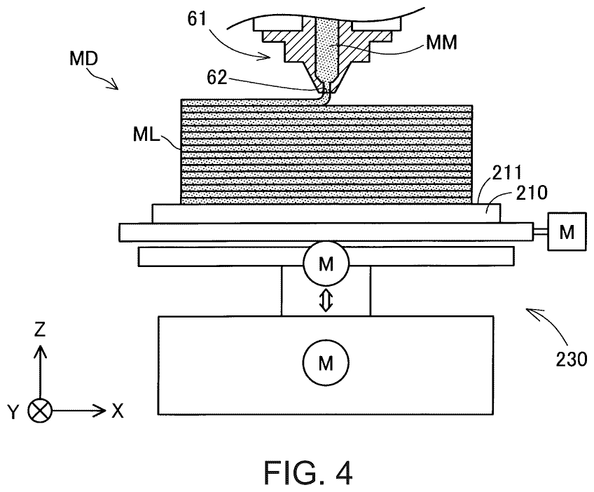

FIG. 4 is an explanatory diagram schematically showing a basic operation of the three dimensional shaping device 100. In the three dimensional shaping device 100, as described above, a shaping material MM is generated by plasticizing the raw material MR in a solid state. The control section 300 maintains the distance between the shaping surface 211 of the stage 210 and the nozzle 61, and ejects the shaping material MM from the nozzle 61 in a direction along the shaping surface 211 of the stage 210 while changing a position of the nozzle 61 with respect to the stage 210. The shaping material MM ejected from the nozzle 61 is continuously deposited in a movement direction of the nozzle 61.

The control section 300 forms shaped layers ML by repeating movement of the nozzle 61 in accordance with a shaping path recorded in shaping data. After forming one shaped layer ML, the control section 300 relatively moves a position of the nozzle 61 with respect to the stage 210 in the +Z direction, which is a layering direction of the shaped layer ML. Then, a three dimensional shaped object MD is shaped by further stacking the shaped layer ML on the shaped layer ML formed so far. Hereinafter, the three dimensional shaped object MD is also simply referred to as a shaped object.

The control section 300 may temporarily stop ejection of a shaping material from the nozzle 61 when shaping of the shaped layer ML for one layer is completed and the nozzle 61 is moved in the +Z direction, or when there are a plurality of independent shaping regions within a single shaped layer ML. In this case, the ejection adjustment section 70 closes the flow path 65 to stop ejection of the shaping material MM from the ejection port 62, and a shaping material in the nozzle 61 is temporarily sucked by the suction section 75. After changing a position of the nozzle 61, the control section 300 resumes deposition of the shaping material MM from the changed position of the nozzle 61 by opening the flow path 65 by the ejection adjustment section 70 while discharging a shaping material in the suction section 75.

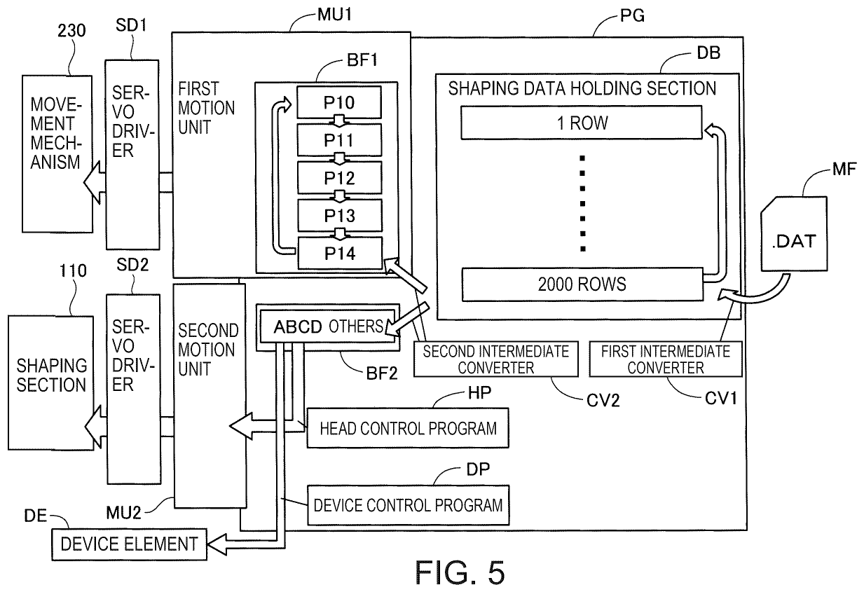

FIG. 5 is an explanatory diagram showing a program structure of the motion control program PG. The motion control program PG includes a first intermediate converter CV1, a second intermediate converter CV2, a first motion unit MU1, a second motion unit MU2, a head control program HP, and a device control program DP.

The first intermediate converter CV1 accesses the shaping file MF in the storage section 320 and loads shaping data from the shaping file MF. The shaping data includes a movement command for moving the nozzle 61 along a shaping path, a head control command for controlling the drive motor 32, the first drive section 74, and the second drive section 76 included in the shaping section 110, and a device control command for controlling input and output of the three dimensional shaping device 100. The first intermediate converter CV1 loads each command as shaping data one by one from the shaping file MF and stores the commands in a shaping data holding section DB secured in the storage section 320.

The shaping data holding section DB includes, for example, a region capable of storing two thousand rows of shaping data. When the first intermediate converter CV1 loads shaping data in two thousand first row from the shaping file MF, the shaping data in the two thousand first row is overwritten on the shaping data in first row. That is, the shaping data holding section DB functions as a ring buffer.

The second intermediate converter CV2 reads shaping data stored in the shaping data holding section DB, sorts the read shaping data according to the type of a command indicated by the shaping data, and transfers the shaping data to the first motion unit MU1 or the second motion unit MU2. In the present embodiment, reading of shaping data from the shaping data holding section DB by the second intermediate converter CV2 and reading of shaping data into the shaping data holding section DB by the first intermediate converter CV1 are performed asynchronously.

The second intermediate converter CV2 transfers a movement command read from the shaping data holding section DB to the first motion unit MU1. The first motion unit MU1 stores the transferred movement command in a movement command buffer BF1. The movement command buffer BF1 includes, for example, a region capable of storing five movement commands. The movement command buffer BF1 is configured as a ring buffer, and when a sixth movement command is transferred, a first region is overwritten. The first motion unit MU1 sequentially loads the movement commands from the movement command buffer BF1, controls a first servo driver SD1 to drive a servo motor provided in the movement mechanism 230 in accordance with the loaded movement commands, and operates the movement mechanism 230.

The second intermediate converter CV2 stores commands, other than the movement command, read from the shaping data holding section DB, in an additional information buffer BF2. The head control program HP reads a head control command from the additional information buffer BF2 and transfers the head control command to the second motion unit MU2. In accordance with the transferred head control command, the second motion unit MU2 controls a second servo driver SD2 to operate the drive motor 32, the first drive section 74, and the second drive section 76 included in the shaping section 110.

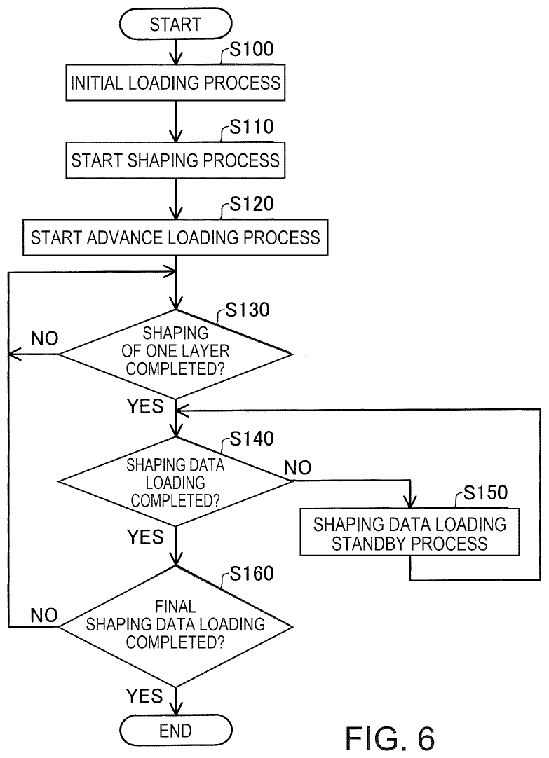

The device control program DP reads a device control command from the additional information buffer BF2 and controls various device elements DE of the three dimensional shaping device 100 through an input/output interface of the control section 300. FIG. 6 is a flowchart of a shaping data loading process executed by the control section 300 in accordance with the motion control program PG. In step S100, the control section 300 executes an initial loading process. In the initial loading process, the first intermediate converter CV1 reads two thousand rows of shaping data from the shaping file MF and stores the shaping data in the shaping data holding section DB. To shape one three dimensional shaped object MD, the shaping file MF includes, for example, 10,000 to 100,000 rows of shaping data. Among them, the number of rows of shaping data for shaping the shaped layer ML for one layer is two thousand or less in many cases. Therefore, in many cases, in the initial loading process, shaping data for forming one or more shaped layers ML is loaded and stored in the shaping data holding section DB.

In step S110, the control section 300 starts a shaping process of shaping the three dimensional shaped object MD. In the shaping process, the second intermediate converter CV2 sequentially transfers commands from the shaping data holding section DB to the movement command buffer BF1 or the additional information buffer BF2. Then, based on the transferred command, the first motion unit MU1 and the second motion unit MU2 control the shaping section 110 and the movement mechanism 230 through the first servo driver SD1 and the second servo driver SD2, thereby shaping the three dimensional shaped object MD for each shaped layer ML. The shaping process includes a step of generating the shaping material MM by plasticizing a material by the plasticizing section 30 and a step of ejecting the shaping material MM from the nozzle 61 toward the stage 210 while changing a relative position between the nozzle 61 and the stage 210.

In step S120, the first intermediate converter CV1 starts an advance loading process of sequentially loading shaping data after the shaping data loaded in step S100. Advance loading refers to loading shaping data into the shaping data holding section DB prior to the control of each section in accordance with the shaping data. The advance loaded shaping data is sequentially overwritten on the oldest shaping data in the shaping data holding section DB configured as a ring buffer. According to step S120, the control section 300 does not load all the shaping data before the three dimensional shaped object MD is shaped, but loads new shaping data into the shaping data holding section DB during a shaping period in which the three dimensional shaped object MD is shaped. The shaping period in which the three dimensional shaped object MD is shaped includes an ejection period in which the shaping material MM is ejected from nozzle 61, and a stop period in which ejection of the shaping material MM from nozzle 61 is stopped. In the advance loading process, the shaping data is loaded into the shaping data holding section DB during both the ejection period and the stop period.

In step S130, the control section 300 determines whether shaping of one layer is completed. For example, the control section 300 determines that the shaping of one layer is completed when a head control command to stop ejection of the shaping material MM from the nozzle 61 and a movement command to move the nozzle 61 in the +Z direction are executed. The control section 300 repeatedly executes the process of step S130 until the shaping of one layer is completed. The shaping process started in step S110 and the advance loading process started in step S120 are executed simultaneously in parallel with the processes in and after step S130.

When it is determined that the shaping of one layer is completed, the control section 300 determines whether loading of the shaping data into the shaping data holding section DB is completed in step S140. When the shaping data is stored in all the rows of the shaping data holding section DB or when the last shaping data recorded in the shaping file MF is stored in the shaping data holding section DB, the control section 300 determines that loading of the shaping data into the shaping data holding section DB is completed. If loading of the shaping data into the shaping data holding section DB is not completed, the control section 300 stands by in step S150 until new shaping data is loaded into all the rows of the shaping data holding section DB by the advance loading process or until the last shaping data is loaded into the shaping data holding section DB. That is, in step S150, the control section 300 loads new shaping data into the shaping data holding section DB during the stop period from the end of shaping of an n-th layer of the three dimensional shaped object MD to the start of shaping of an (n+1)-th layer to be shaped after the n-th layer. Note that n is a natural number.

When it is determined in step S140 that loading of the shaping data into the shaping data holding section DB is completed, the control section 300 determines in step S160 whether the last shaping data is loaded into the shaping data holding section DB. If the last shaping data has not been loaded, the control section 300 returns the process to step S130. By returning the process to step S130, the process of step S130 is repeatedly executed until shaping of the next layer is completed. When it is determined that the last shaping data has been loaded into the shaping data holding section DB, the control section 300 ends the shaping data loading process. Even after the completion of the shaping data loading process, the shaping process started in step S110 is continued as long as shaping data remains in the shaping data holding section DB.

According to the three dimensional shaping device 100 of the first embodiment described above, the control section 300 does not load all the shaping data necessary for shaping one three dimensional shaped object MD before the start of shaping of the three dimensional shaped object MD, but loads new shaping data while shaping the three dimensional shaped object MD during the shaping period in which the three dimensional shaped object MD is shaped. Therefore, it is possible to rapidly start the shaping of the three dimensional shaped object MD.

In the present embodiment, for example, during the stop period of the shaping period, during which ejection of shaping material from the nozzle 61 is stopped, such as the stop period from when shaping of a first layer of the three dimensional shaped object MD is completed until when shaping of a second layer that is shaped after the first layer is started, the control section 300 loads new shaping data into the shaping data holding section DB. Therefore, in order to load new shaping data, it is not necessary to interrupt shaping by stopping ejection of shaping material from the nozzle 61 during the shaping period. As a result, it is possible to suppress a decrease in shaping speed due to loading of new shaping data.

In the present embodiment, during the stop period of the nozzle 61, if the shaping data holding section DB is filled with shaping data, the control section 300 does not load new shaping data, and if the shaping data holding section DB is not filled with shaping data, it loads new shaping data. Therefore, standby time for loading new shaping data can be minimized, and shaping of the next layer can be quickly started.

In the present embodiment, the shaping data holding section DB and the movement command buffer BF1 are each configured as a ring buffer. Therefore, regardless of the size of the shaping file MF, the three dimensional shaped object MD can be shaped with a small storage region.

In the first embodiment, the control section 300 loads new shaping data when the shaping data holding section DB is not filled at the time of completion of shaping of one layer. On the other hand, the control section 300 may load new shaping data when the shaping data holding section DB is not filled at the time when shaping of an arbitrary number of layers such as two layers or three layers is completed.

B. SECOND EMBODIMENT

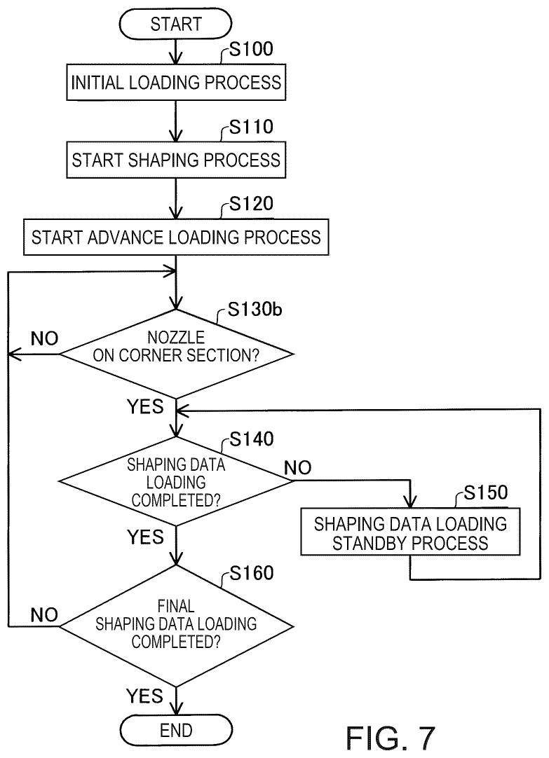

FIG. 7 is a flowchart of a shaping data loading process executed by the control section 300 according to a second embodiment. The configuration of the three dimensional shaping device 100 in the second embodiment is the same as that in the first embodiment. In the flowchart of FIG. 7, the same step numbers are assigned to the same processing contents as those of the shaping data loading process of the first embodiment shown in FIG. 6.

In step S100, similarly to the first embodiment, the first intermediate converter CV1 executes the initial loading process of reading two thousand rows of shaping data and storing the two thousand rows of shaping data in the shaping data holding section DB. In step S110, the control section 300 starts the shaping process of shaping the three dimensional shaped object MD. In step S120, the first intermediate converter CV1 starts the advance loading process of sequentially loading shaping data following the shaping data loaded in step S100.

In step S130b, the control section 300 determines whether the nozzle 61 shaping the three dimensional shaped object MD is positioned at a corner section CN of the three dimensional shaped object MD.

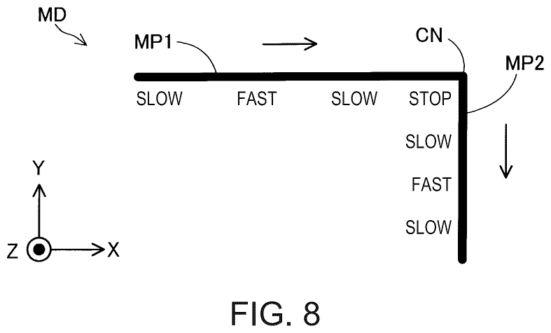

FIG. 8 is a diagram schematically showing a part of the three dimensional shaped object MD. The three dimensional shaped object MD is shaped based on a plurality of shaping paths. The three dimensional shaped object MD shown in FIG. 8 includes a first shaping path MP1 and a second shaping path MP2. The second shaping path MP2 is in contact with the first shaping path MP1. The first shaping path MP1 and the second shaping path MP2 are each a linear path. The first shaping path MP1 and the second shaping path MP2 are in contact with each other at an angle. The expression “the first shaping path MP1 and the second shaping path MP2 are in contact with each other at an angle” means that the first shaping path MP1 and the second shaping path MP2 connected to each other are not positioned on a straight line. In FIG. 8, the first shaping path MP1 and the second shaping path MP2 are in contact with each other at an angle of 90 degrees. In step S130b, the control section 300 determines that the nozzle 61 is positioned at the corner section CN when the nozzle 61 is positioned at a position corresponding to an intersection point between the first shaping path MP1 and the second shaping path MP2, which are in contact with each other at an angle. In the present embodiment, when the nozzle 61 is positioned at the corner section CN, the control section 300 stops the movement of the nozzle 61 for a predetermined period after reducing the movement speed of the nozzle 61 at the corner section CN.

When it is determined that the nozzle 61 is positioned at the corner section CN, the control section 300 determines in step S140 whether loading of shaping data to the shaping data holding section DB is completed. When the shaping data is stored in all the rows of the shaping data holding section DB or when the last shaping data recorded in the shaping file MF is stored in the shaping data holding section DB, the control section 300 determines that loading of the shaping data into the shaping data holding section DB is completed. If loading of the shaping data into the shaping data holding section DB is not completed, the control section 300 stands by in step S150 until shaping data is loaded into all the rows of the shaping data holding section DB by the advance loading process or until the last shaping data is loaded into the shaping data holding section DB. That is, in step S150, the control section 300 loads new shaping data into the shaping data holding section DB during a period when the nozzle 61 is positioned at a position corresponding to the intersection point between the first shaping path MP1 and the second shaping path MP2.

When it is determined in step S140 that loading of the shaping data into the shaping data holding section DB is completed, the control section 300 determines in step S160 whether the last shaping data is loaded into the shaping data holding section DB. If the last shaping data is not loaded, the control section 300 returns the process to step S130b. When it is determined that the last shaping data has been loaded into the shaping data holding section DB, the control section 300 ends the shaping data loading process.

According to the second embodiment described above, the control section 300 loads new shaping data into the shaping data holding section DB during the period when the nozzle 61 is at the position corresponding to the intersection point between the first shaping path MP1 and the second shaping path MP2. As a result, since shaping data can be loaded in a period in which the movement speed of the nozzle 61 decreases during the shaping period, it is possible to suppress a decrease in the shaping speed due to loading of new shaping data. In particular, in the present embodiment, the movement of the nozzle 61 is stopped at the intersection point between the first shaping path MP1 and the second shaping path MP2. Therefore, it is not necessary to interrupt shaping by stopping the movement of the nozzle 61 during the shaping period in order to load new shaping data. As a result, it is possible to suppress a decrease in shaping speed due to loading of new shaping data.

In the second embodiment, when the nozzle 61 is positioned at the corner section CN where the connection angle between the first shaping path MP1 and the second shaping path MP2 is equal to or larger than a predetermined angle, the control section 300 may stop the movement of the nozzle 61 and load new shaping data. By doing so, the number of times the movement of the nozzle 61 is stopped can be reduced, so that it is possible to suppress a decrease in the shaping speed.

In the second embodiment, the control section 300 stops the movement of the nozzle 61 at the corner section CN of the three dimensional shaped object MD. In contrast, the control section 300 may only decrease the movement speed without stopping the movement of the nozzle 61 at the corner section CN. In this case, the control section 300 loads new shaping data while the movement speed of the nozzle 61 is decreasing. Also in such a case, since it is possible to load shaping data in a period in which the movement speed of the nozzle 61 during the shaping period is reduced, it is possible to suppress the shaping speed decreases with loading of new shaping data. Note that when new shaping data is loaded while the movement speed is decreasing, the control section 300 omits the process of step S140 and step S150 shown in FIG. 7, and reads as much shaping data as possible from the shaping file MF and stores the shaping data in the shaping data holding section DB during a period in which the shaping speed is decreasing.

In the second embodiment, the control section 300 loads new shaping data when the nozzle 61 is positioned at the intersection point between the shaping paths. The timing at which new shaping data is loaded is not limited thereto, and for example, in a case where each layer of the three dimensional shaped object MD is constituted by an outer region and an infill region, the shaping data may be loaded during a period from the completion of shaping of the outer region to the start of shaping of the infill region. When the three dimensional shaped object MD includes a main body section and a support structure, at the timing of changing a shaping portion from the main body section to the support structure, or at the timing of changing a shaping portion from the support structure to a main body section, shaping data may be loaded. The timing of changing the type of the shaping material MM, such as the timing of changing a line width of a shaping path, during the shaping period, at the timing of the aspect of shaping is changed, new shaping data may be loaded.

### C. Other Embodiments

(C1) In the above-described embodiment, the shaping data holding section DB is configured as a ring buffer. On the other hand, the shaping data holding section DB may be configured as a normal buffer.

(C2) In the above-described embodiment, the control section 300 loads shaping data from the shaping file MF in the initial loading process of step S100 shown in FIGS. 6 and 7 so that the shaping data holding section DB is filled with the shaping data. On the other hand, the control section 300 may omit the execution of the initial loading process and may start the shaping process while loading shaping data into the shaping data holding section DB by the advance loading process.

(C3) In the above-described embodiment, the control section 300 loads new shaping data from the shaping file MF into the shaping data holding section DB during both the ejection period and the stop period within the shaping period. In contrast, the control section 300 may not load shaping data during the ejection period of the shaping period, and may load new shaping data only during the stop period from the completion of shaping of the first layer of the three dimensional shaped object MD to the start of the shaping of the second layer, or during the stop period when the movement of the nozzle 61 is stopped at the corner section CN of the three dimensional shaped object MD.

(C4) In the above-described embodiment, the shaping section 110 plasticizes a material by the flat screw 40. In contrast, the shaping section 110 may plasticize a material by rotating an in-line screw, for example. The shaping section 110 may plasticize filamentous material with a heater.

### D. Other Aspects

The present disclosure is not limited to the above-described embodiments and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, they can be appropriately deleted.

(1) According to a first aspect of the present disclosure, the three dimensional shaping device is provided.

The three dimensional shaping device includes a plasticizing section that plasticizes a material to generate a shaping material; a nozzle that communicates with the plasticizing section and that includes an ejection port for ejecting the shaping material toward a stage; a movement mechanism that changes a relative position between the nozzle and the stage; a shaping data holding section that holds shaping data for shaping a three dimensional shaped object; and a control section that controls ejection of the shaping material from the nozzle and the movement mechanism in accordance with the shaping data read from the shaping data holding section to shape the three dimensional shaped object, wherein the control section loads new shaping data into the shaping data holding section during a shaping period in which the three dimensional shaped object is shaped.

According to such an aspect, not all the shaping data is loaded prior to the shaping period in which the three dimensional shaped object is shaped, but new shaping data is loaded into the shaping data holding section in the shaping period in which the three dimensional shaped object is shaped. Therefore, it is possible to rapidly start shaping of the three dimensional shaped object.

(2) The above-described aspect may be configured such that the shaping period includes an ejection period in which a shaping material is ejected from the nozzle and a stop period in which ejection of a shaping material from the nozzle is stopped and the control section loads new shaping data into the shaping data holding section during the stop period.

According to such an aspect, it is possible to suppress a decrease in the shaping speed due to loading of new shaping data.

(3) The above-described aspect may be configured such that during the stop period, the control section does not load the new shaping data when the shaping data holding section is filled with the shaping data, and loads the new shaping data when the shaping data holding section is not filled with the shaping data.

According to such an aspect, it is possible to minimize the standby time for loading new shaping data.

(4) The above-described aspect may be configured such that the control section loads new shaping data into the shaping data holding section during the stop period from when shaping of a first layer of the three dimensional shaped object is completed to when shaping of a second layer, which is shaped after the first layer, is started.

According to such an aspect, it is possible to suppress a decrease in the shaping speed due to loading of new shaping data.

(5) The above-described aspect may be configured such that the three dimensional shaped object is shaped based on a plurality of shaping paths including a first shaping path and a second shaping path in contact with the first shaping path and the control section loads new shaping data into the shaping data holding section during a period when the nozzle is positioned at a position corresponding to an intersection point between the first shaping path and the second shaping path.

In such an aspect, it is possible to load shaping data in a period in which the movement speed of the nozzle during the shaping period decreases. Therefore, it is possible to suppress a decrease in the shaping speed due to loading of new shaping data.

(6) The above-described aspect may be configured such that the first shaping path and the second shaping path are in contact with each other at an angle.

In such an aspect, it is possible to load shaping data in a period in which the movement speed of the nozzle during the shaping period decreases. Therefore, it is possible to suppress a decrease in the shaping speed due to loading of new shaping data.

The present disclosure is not limited to the above-described three dimensional shaping device, and can be realized by various aspects such as a manufacturing method for a three dimensional shaped object, a computer program, and a non-transitory tangible recording medium in which a computer program is recorded in a computer-readable manner.

What is claimed is:

1. A three dimensional shaping device comprising:
a plasticizing section that plasticizes a material to generate a shaping material;
a nozzle that communicates with the plasticizing section and that includes an ejection port for ejecting the shaping material toward a stage;
a movement mechanism that changes a relative position between the nozzle and the stage;
a shaping data holding section that holds shaping data for shaping a three dimensional shaped object; and
a control section that controls ejection of the shaping material from the nozzle and the movement mechanism in accordance with the shaping data read from the shaping data holding section to shape the three dimensional shaped object, wherein
the control section loads new shaping data into the shaping data holding section during a shaping period in which the three dimensional shaped object is shaped.

2. The three dimensional shaping device according to claim 1, wherein
the shaping period includes an ejection period in which a shaping material is ejected from the nozzle and a stop period in which ejection of a shaping material from the nozzle is stopped and
the control section loads new shaping data into the shaping data holding section during the stop period.

3. The three dimensional shaping device according to claim 2, wherein
during the stop period, the control section does not load the new shaping data when the shaping data holding section is filled with the shaping data, and loads the new shaping data when the shaping data holding section is not filled with the shaping data.

4. The three dimensional shaping device according to claim 2, wherein
the control section loads new shaping data into the shaping data holding section during the stop period from when shaping of a first layer of the three dimensional shaped object is completed to when shaping of a second layer, which is shaped after the first layer, is started.

5. The three dimensional shaping device according to claim 1, wherein
the three dimensional shaped object is shaped based on a plurality of shaping paths including a first shaping path and a second shaping path in contact with the first shaping path and
the control section loads new shaping data into the shaping data holding section during a period when the nozzle is positioned at a position corresponding to an intersection point between the first shaping path and the second shaping path.

6. The three dimensional shaping device according to claim 5, wherein
the first shaping path and the second shaping path are in contact with each other at an angle.

7. A manufacturing method for a three dimensional shaped object comprising:
a step of plasticizing a material by a plasticizing section to generate a shaping material;
a step of a control section causing ejection of the shaping material from a nozzle toward a stage while changing a relative position between the nozzle and a stage in accordance with shaping data read from a shaping data holding section that holds the shaping data for shaping a three dimensional shaped object; and
a step of loading new shaping data into the shaping data holding section by the control section, wherein
during a shaping period in which the three dimensional shaped object is shaped, the new shaping data is loaded into the shaping data holding section.
